(19) United States
(12) Patent Application Publication
(10) Pub. No.: US 2018/0091733 A1
(43) Pub. Date: Mar. 29, 2018

(54) CAPTURING IMAGES PROVIDED BY USERS

(71) Applicant: Hewlett-Packard Development Company, L.P., Houston, TX (US)

(72) Inventor: Donald J Fasen, Boise, ID (US)

(21) Appl. No.: 15/567,423

(22) PCT Filed: Jul. 31, 2015
(86) PCT No.: PCT/US2015/043308

§ 371 Date: Oct. 18, 2017

(51) Int. Cl. H04N 5/232; G06T 5/50; H04N 9/31; G06F 3/01; G06T 1/00

(52) U.S. Cl. CPC H04N 5/23232; G06T 5/50; G06T 1/0007; H04N 9/3194; G06F 3/01; H04N 5/23293

(57) ABSTRACT

In an example implementation according to aspects of the present disclosure, a method may include capturing an image from a mat or from an object physically disposed on the mat, and comparing the captured image to an image projected by a projector assembly onto the mat or onto the object. The method further includes subtracting the image projected by the projector assembly from the captured image to generate a remainder image assigned as input provided by a user.

### BACKGROUND

Effective communication between different parties is an important part of today's world. With the increased availability of high-speed network connectivity, video conferencing conducted over networks between participants in different locations has become popular.

### BRIEF DESCRIPTION OF THE DRAWINGS

The following detailed description references the drawings, wherein:

FIG. 1 is block diagram of a computing system, according to an example;

FIGS. 2A-C provides an illustration of determining content added by a user, in order to reduce a likelihood of any regenerative image feedback and image echo artifacts, according to an example; and

FIG. 3 is a flow diagram depicting steps to implement an example.

### DETAILED DESCRIPTION

Remote collaboration and videoconferencing systems enable remotely located users at several different sites to simultaneously collaborate with one another via interactive video and audio transmissions. A user at one location can see and interact with a user at other locations in real-time and without noticeable delay.

Examples disclosed herein provide real-time remote sharing and collaboration of drawings between users at remote locations. For example, the users may communicate remotely via hand-drawn sketches or pictures on a regular piece of paper. As a first user makes marks on their paper, those marks may be captured and projected on the papers of the other users at remote sites, as will be further described. As a result, the users at the remote sites thereby get the impression that the sketch is being drawn locally. Additionally, the users at the remote sites can also participate in the sketch and add to the drawing, allowing for all the users, including the first user, to see these updates as well. For example, each user may add notes or refinements to the drawing on their respective papers, which would then be displayed on the papers of all users.

As an example, the content from each user may be separated, such as allowing display in different colors or another distinguishing manner, so the contribution from each user is clear. When finished, the merged drawing could be saved and sent to all the users. The remote sharing and collaboration of drawings between users at remote locations allow for a natural and precise method for human communication, as would be done in a face to face meeting.

The system described herein refer to interactive collaboration and videoconferencing systems that share digital audio or visual media between remote users. The terms local site and remote site are descriptive terms that define a physical separation between the described systems, persons, or objects and other systems, persons, or objects. The physical separation may be any suitable distance between locations such as a short distance within the same room or between adjacent rooms of a building or a long distance between different countries or continents. The term local user refers to a person who views a local system, and the term remote user refers to a person who views a remote system.

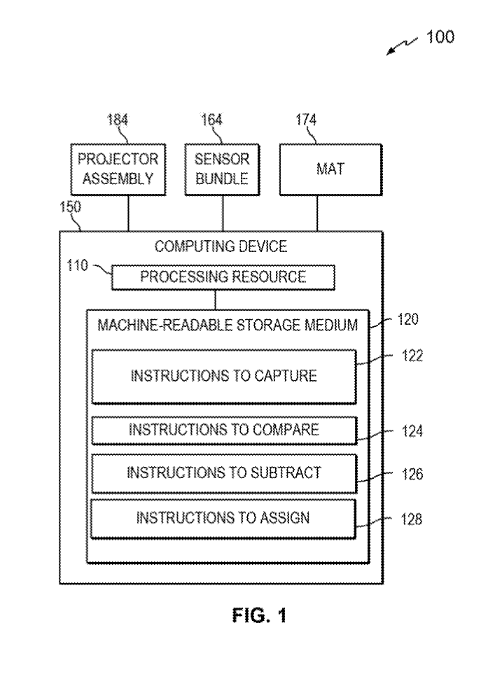

Referring now to the drawings, FIG. 1 is a block diagram of a computing system 100, according to an example. In general, the system 100 comprises a computing device 150 that is communicatively connected to a projector assembly 184, sensor bundle 164, and projection mat 174. As will be further described, a local user may utilize a computing system 100 to remotely share drawings between remote users that also utilize computing systems 100. The functionality provided by the computing systems 100 provide for real-time remote sharing and collaboration of the drawings between the users.

Computing device 150 may comprise any suitable computing device complying with the principles disclosed herein. As used herein, a “computing device” may comprise an electronic display device, a smartphone, a tablet, a chip set, an all-in-one computer (e.g., a device comprising a display device that also houses processing resource(s) of the computer), a desktop computer, a notebook computer, workstation, server, any other processing device or equipment, or a combination thereof.

As an example, the projection mat 174 may comprise a touch-sensitive region. The touch-sensitive region may comprise any suitable technology for detecting physical contact (e.g., touch input), such as, for example, a resistive, capacitive, surface acoustic wave, infrared (IR), strain gauge, optical imaging, acoustic pulse recognition, dispersive signal sensing, or in-cell system, or the like. For example, the touch-sensitive region may comprise any suitable technology for detecting (and in some examples tracking) one or multiple touch inputs by a user to enable the user to interact, via such touch input, with software being executed by device 150 or another computing device. In examples described herein, the projection mat 174 may be any suitable planar object, such as a screen, tabletop, sheet, etc. In some examples, the projection mat 174 may be disposed horizontally (or approximately or substantially horizontal). For example, mat 174 may be disposed on a support surface, which may be horizontal (or approximately or substantially horizontal).

Projector assembly 184 may comprise any suitable digital light projector assembly for receiving data from a computing device (e.g., device 150) and projecting image(s) that correspond with that input data. For example, in some implementations, projector assembly 184 may comprise a digital light processing (DLP) projector or a liquid crystal on silicon (LCoS) projector which are advantageously compact and power efficient projection engines capable of multiple display resolutions and sizes, such as, for example, standard XGA resolution (1024×768 pixels) with a 4:3 aspect ratio, or standard WXGA resolution (1280×800 pixels) with a 16:10 aspect ratio.

Projector assembly 184 is further communicatively connected (e.g., electrically coupled) to device 150 in order to receive data therefrom and to produce (e.g., project) light and image(s) based on the received data. Projector assembly 184 may be communicatively connected to device 150 via any suitable type of electrical coupling, for example, or any other suitable communication technology or mechanism described herein. In some examples, assembly 184 may be communicatively connected to device 150 via electrical conductor(s), WI-FI, BLUETOOTH, an optical connection, an ultrasonic connection, or a combination thereof. As will be further described, light, image(s), etc., projected from the projector assembly 184 may be directed toward the projection mat 174 during operation.

Sensor bundle 164 includes a plurality of sensors (e.g., cameras, or other types of sensors) to detect, measure, or otherwise acquire data based on the state of (e.g., activities occurring in) a region between sensor bundle 164 and the projection mat 174. The state of the region between sensor bundle 164 and the projection mat 174 may include object(s) on or over the projection mat 174, or activit(ies) occurring on or near the projection mat 174. As an example, the sensor bundle 164 may include an RGB camera (or another type of color camera), an IR camera, a depth camera (or depth sensor), and an ambient light sensor.

As an example, the sensor bundle 164 may be pointed toward the projection mat 174 and may capture image(s) of mat 174, object(s) disposed between mat 174 and sensor bundle 164 (e.g., on or above mat 174), or a combination thereof. In examples described herein, the sensor bundle 164 is communicatively connected (e.g., coupled) to device 150 such that data generated within bundle 164 (e.g., images captured by the cameras) may be provided to device 150, and device 150 may provide commands to the sensor(s) and camera(s) of sensor bundle 164. In some examples, the sensor bundle 164 is arranged within system 100 such that the field of view of the sensors may overlap with some or all of projection mat 174. As a result, functionalities of projection mat 174, projector assembly 184, and sensor bundle 164 are all performed in relation to the same defined area.

Computing device 150 may include at least one processing resource. In examples described herein, a processing resource may include, for example, one processor or multiple processors included in a single computing device or distributed across multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution instructions stored on a machine-readable storage medium, or a combination thereof.

Referring to FIG. 1, the computing device 150 includes a processing resource 110, and a machine-readable storage medium 120 comprising (e.g., encoded with) instructions 122, 124, 126, and 128. In some examples, storage medium 120 may include additional instructions. In other examples, instructions 122, 124, 126, and 128, and any other instructions described herein in relation to storage medium 120, may be stored on a machine-readable storage medium remote from but accessible to computing device 150 and processing resource 110. Processing resource 110 may fetch, decode, and execute instructions stored on storage medium 120 to implement the functionalities described below. In other examples, the functionalities of any of the instructions of storage medium 120 may be implemented in the form of electronic circuitry, in the form of executable instructions encoded on a machine-readable storage medium, or a combination thereof. Machine-readable storage medium 120 may be a non-transitory machine-readable storage medium.

In some examples, the instructions can be part of an installation package that, when installed, can be executed by the processing resume 110. In such examples, the machine-readable storage medium may be a portable medium, such as a compact disc, DVD, or flash drive, or a memory maintained by a server from which the installation package can be downloaded and installed. In other examples, the instructions may be part of an application or applications already installed on a computing device including the processing resource (e.g., device 150). In such examples, the machine-readable storage medium may include memory such as a hard drive, solid state drive, or the like.

As used herein, a “machine-readable storage medium” may be any electronic, magnetic, optical, or other physical storage apparatus to contain or store information such as executable instructions, data, and the like. For example, any machine-readable storage medium described herein may be any of a storage drive (e.g., a hard drive), flash memory, Random Access Memory (RAM), any type of storage disc (e.g., a compact disc, a DVD, etc.), and the like, or a combination thereof. Further, any machine-readable storage medium described herein may be non-transitory.

As mentioned above, each user in a collaboration environment may utilize a computing system 100. For example, each user may connect to other remote users with a sheet or pad of paper physically disposed on the mat 174. However, the users may also connect to each other by writing directly on the mat 174 as well. With regards to an object physically disposed on the mat 174, such as the sheet or pad of paper, an initial capture of each user's paper may be taken via the sensor bundle 164 and used to set the points or edges of each user's paper. By detecting the boundaries of the paper, any background clutter surrounding the paper, such as other objects on the mat 174, may be removed from current and subsequent images shared with the other users.

As will be further described, as a user makes marks on their paper, those marks may be captured by the sensor bundle 164 of their computing system 100, and projected on the papers of the other users, for example, by the projector assemblies 184 of the computing system 100 of the other users. As an example, if a user moves their paper, the sensor bundle 164 will identify this shift and realign the projected image to the content on that user's paper. The identity of this shift may be made possible by the initial detection of the boundaries of the paper.

As an example, in order to reduce a likelihood of any regenerative image feedback and image echo artifacts, content added by a user on their paper may not be re-projected by the projector assembly 184 on their paper. As a result, only the combined content from other users may be projected on their paper. As will be further described, the content added by the user on their paper may be separated from the content projected by the projector assembly 184 by subtracting the projected image from the total image captured with the sensor bundle 164.

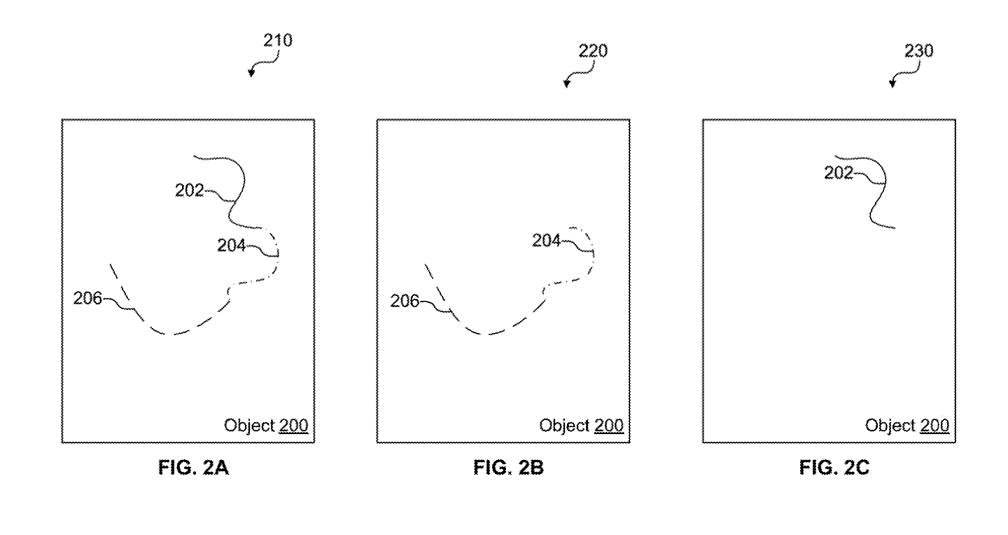

FIGS. 2A-C provides an illustration of determining the content added by a user, in order to reduce a likelihood of any regenerative image feedback and image echo artifacts, according to an example. Referring to FIG. 2A, an object 200 physically disposed on the projection mat 174, such as a sheet or pad of paper, includes input 202 physically provided by a local user on the object 200, and inputs 204, 206 provided by remote users and projected via the projector assembly 184 onto the object 200. An image 210 of the input 202 provided by the local user and inputs 204, 206 provided by the remote users may be captured by the sensor bundle 164.

In order to reduce a likelihood of the regenerative image feedback mentioned above, the projector assembly 184 of the computing system belonging to the local user may not project the input 202 provided by the local user themselves. As an example, a frame by frame subtraction approach may be used. For example, FIG. 2B illustrates the image 220 projected by the projector assembly 184 in the frame prior to when input 202 is provided by the local user. As illustrated, the image 220 includes inputs 204, 206, which may have been provided by remote users in earlier frames.

Upon comparing the image 210 captured by the sensor bundle 164 and the image 220 projected by the projector assembly 184 in the previous frame, the computing device 150 may subtract image 220 from image 210 in order to determine the remainder image 230 containing the input 202 provided by the local user, as illustrated in FIG. 2C. As an example, this remainder image 230 is not then projected by the projector assembly 184 of the computing system belonging to the local user, in order to reduce a likelihood of the regenerative image feedback. However, the computing system 100 may transmit the remainder image 230 to be projected by projector assemblies of systems belonging to the remote users.

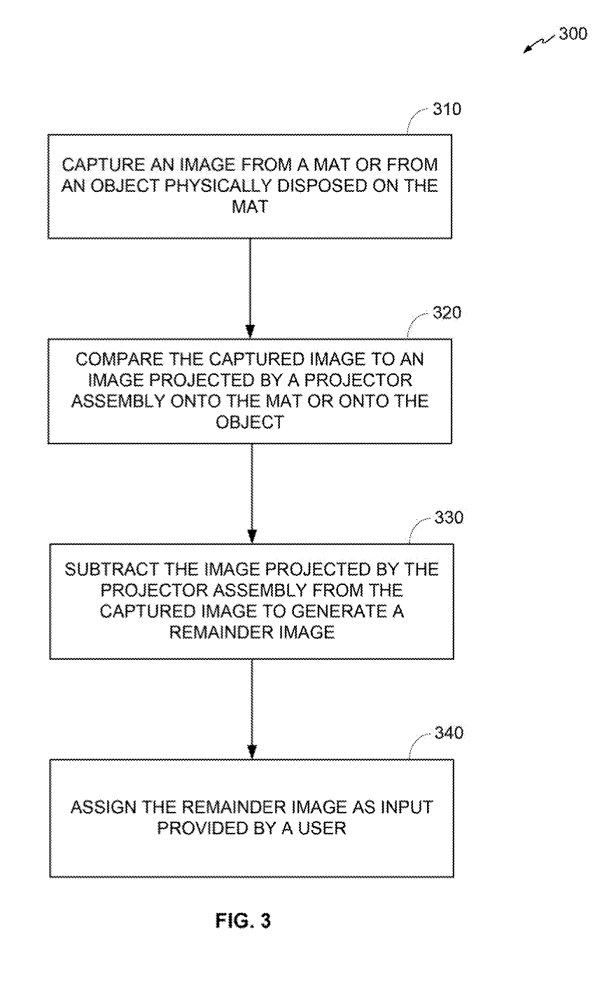

FIG. 3 is a flowchart of an example method 300 for implementing a subtractive method in order to reduce a likelihood of regenerative image feedback and image echo artifacts. Although execution of method 300 is described below with reference to computing system 100 of FIG. 1, other suitable systems for execution of method 300 can be utilized. Additionally, implementation of method 300 is not limited to such examples.

At 310 of method 300, sensor bundle 164 of system 100 belonging to a local user may capture an image from the projection mat 174 or from an object physically disposed on the mat 174 (e.g., object 200 in FIG. 2A). At 320, the computing device 150 of system 100 may compare the captured image to an image projected by the projector assembly 184 onto the mat 174 or onto the object. As described above, the computing device 150 may compare using an image projected by the projector assembly 184 from the frame prior to the frame when the sensor bundle 164 captured the image. As an example, the image projected by the projector assembly 184 may include images provided by other users remote from the local user. The projected images may be in different colors or another distinguishing manner from any input provided by the local user, so contributions from each user may be clear.

At 330, the computing device 150 may subtract the image projected by the projector assembly 184 from the captured image to generate a remainder image. At 340, the computing device 150 may assign the remainder image as input provided by the local user of the computing system 100. As an example, the computing system 100 may transmit the remainder image to be projected by other projector assemblies onto other mats or onto other objects disposed on the other mats of systems of the other users remote from the local user. However, the remainder image may not be projected onto the mat 174 of the computing system 100 of the local user, in order to reduce a likelihood of the regenerative image feedback described above.

As an example, if the local user is utilizing an object on the mat 174 for collaborating with the remote users, the computing system 100 may track an orientation of the object physically disposed on the mat 174, for example, via the sensor bundle 164. The sensor bundle 164 may detect the boundaries of the object in order to track the orientation. Upon tracking a change in the orientation, or a movement of the object on the mat 174, the projector assembly 184 may adjust or realign the projected images provided by the remote users, such that the projected images are correctly oriented on the object.

Although the flowchart of FIG. 3 shows a specific order of performance of certain functionalities, method 300 is not limited to that order. For example, the functionalities shown in succession in the flowchart may be performed in a different order, may be executed concurrently or with partial concurrence, or a combination thereof. In some examples, features and functionalities described herein in relation to FIG. 3 may be provided in combination with features and functionalities described herein in relation to any of FIGS. 1-2C.

What is claimed is

1. A method comprising:
capturing an image from a mat or from an object physically disposed on the mat;
comparing the captured image to an image projected by a projector assembly onto the mat or onto the object;
subtracting the image projected by the projector assembly from the captured image to generate a remainder image; and
assigning the remainder image as input provided by a user.

2. The method of claim 1, comprising:
transmitting the remainder image to be projected by other projector assemblies onto other mats or onto other objects disposed on the other mats of systems of other users remote from the user.

3. The method of claim 2, comprising:
receiving images provided by the other users; and
projecting the images provided by the other users onto the mat or onto the object.

4. The method of claim 3, wherein the remainder image provided as input by the user is not projected onto the mat or onto the object.

5. The method of claim 3, comprising;
tracking an orientation of the object physically disposed on the mat; and
adjusting the projected images provided by the other users such that the projected images are correctly oriented on the object.

6. The method of claim 3, wherein the projected images provided by the other users are in different colors from the remainder image provided as input by the user.

7. A system comprising:
a plurality of sensors;
a projector assembly;
a computing device; and
a mat communicatively coupled to the computing device, on to which the projector assembly is to project an image, wherein the computing device is to cause:
the plurality of sensors to capture an image from the mat;
the computing device to compare the captured image to the image projected by the projector assembly onto the mat; and
the computing device to subtract the image projected by the projector assembly from the captured image to generate a remainder image assigned as input provided by a user.

8. The system of claim 7, wherein the computing device is to transmit the remainder image to be projected by other projector assemblies onto other mats or onto other objects disposed on the other mats of systems of other users remote from the user.

9. The system of claim 8, wherein the computing device is to cause:
the computing device to receive images provided by the other users; and
the projector assembly to project the images provided by the other users onto the mat or onto the object.

10. The system of claim 9, wherein the remainder image provided as input by the user is not projected onto the mat or onto the object.

11. The system of claim 9, wherein the computing device is to cause:
the computing device to track an orientation of the object physically disposed on the mat; and
the projector assembly to adjust the projected images provided by the other users such that the projected images are correctly oriented on the object.

12. The system of claim 9, wherein the projected images provided by the other users are in different colors from the remainder image provided as input by the user.

13. A non-transitory machine-readable storage medium comprising instructions executable by a processing resource of a computing system comprising a mat, a projector assembly to project images on the mat, and a plurality of sensors disposed above and pointed at the mat, the instructions executable to:
capture an image from the mat or from an object physically disposed on the mat;
compare the captured image to an image projected by the projector assembly onto the mat or onto the objects;
subtract the image projected by the projector assembly from the captured image to generate a remainder image; and
assign the remainder image as input provided by a user.

14. The non-transitory storage medium of claim 13, comprising instructions executable to:
transmit the remainder image to be projected by other projector assemblies onto other mats or onto other objects disposed on the other mats of systems of other users remote from the user.

15. The non-transitory storage medium of claim 14, comprising instructions executable to:
receive images provided by the other users; and
project the images provided by the other users onto the mat or onto the object.
